(19) United States
(12) Patent Application Publication
(10) Pub. No.: US 2005/0269544 A1
(43) Pub. Date: Dec. 8, 2005

(54) Reducing the torque required for repositioning a valve member of a ball valve

(75) Inventor: Michael Hung-Sun Oh, Rockford, IL (US)

Correspondence Address: REINHART BOERNER VAN DEUREN LTD., 483 NORTH MULFORD ROAD, SUITE 7, ROCKFORD, IL, 61107, US

(73) Assignee: Invensys Building Systems, Loves Park, IL (US)

(21) Appl. No.: 10/859,157

(22) Filed: Jun. 2, 2004

(51) Int. Cl. F16K 5/06

(52) U.S. Cl. 251/315.01

(57) ABSTRACT

An apparatus and method are provided for reducing the torque required to reposition a valve member of a ball valve, by maintaining continuous fluid communication between a cavity surrounding the valve member and an upstream flow-through end of a valve body of the ball valve, regardless of the alignment of the valve member with respect to the upstream flow-through end of the valve body. The continuous fluid communication is provided by a seal bypass passage that is defined alternatively, by the valve body, an upstream seal, or by one or more holes passing through an outer wall of the valve member that faces toward the upstream flow-through end of the valve body when the valve member is in the closed position.

### FIELD OF THE INVENTION

This invention relates to ball valves having a valve member which may be turned between open and closed positions, and having an outer surface contacted by upstream and downstream seal elements operatively connected between the valve member and a valve body surrounding the valve member, and more particularly to an apparatus and method for reducing the torque required for turning the valve member of such a ball valve.

### BACKGROUND OF THE INVENTION

It is generally advantageous to reduce the torque required for repositioning the valve member in a ball valve. This is especially true for ball valves having an actuator motor connected to the valve member for repositioning the valve member, because lowering the torque requirement will allow a smaller actuator to be utilized. Generally speaking, smaller actuators can be produced at lower cost than larger actuators, and require less input power, thereby reducing both the initial cost and the operating cost of the actuator.

The invention disclosed herein is applicable to ball valves having a valve body, and a valve member operatively connected to the valve body by an upstream and a downstream seal. The valve body defines a flow passage having an upstream flow-through end, a downstream flow-through end, and a valve receiving chamber located between the upstream and downstream flow-through ends of the flow passage. The valve member is located within the valve receiving chamber, and includes a throughbore that allows passage of fluid through the valve member. The seals, in conjunction with the valve member and the valve receiving chamber, define a cavity around the valve member.

The valve member is selectively rotatable within the valve receiving chamber, between a fully open position and a fully closed position. Generally, in a two way valve, the fully open position occurs when the throughbore is perfectly aligned with the flow passage at zero degrees of rotation from a centerline of the flow passage, and the fully closed position occurs at ninety degrees of rotation of the valve member from the centerline.

There are three operating conditions which have historically required high torques, for repositioning the valve members in prior actuator driven ball valves.

The first of these three conditions occurs when a ball valve is first installed in the field, before the valve member is moved for the first time, because the juncture of the seal elements with the surface of the valve member is essentially dry, i.e. not lubricated with fluid. The fluid pressure acting on the valve member also tends to press the valve member into the downstream seal, causing deformation of the relatively soft material used for the seal, and further increases both the static and dynamic friction between the valve member and the downstream seal. This loading of the valve member into the downstream seal, and the resulting deformation of the downstream seal, takes place regardless of whether the valve is installed in an open or a closed position, although the effect is more severe for valves installed for the first time with the valve element in the closed position. The combined effects of the seal interface being essentially dry, and the deformation of the downstream cause the initial breakaway torque, and the dynamic torque, to be higher for a valve the first time that the valve member is repositioned.

The second condition, at which high torque is encountered, occurs every time the valve member is repositioned to or from a fully closed position of the valve, due to inherent operational characteristics of a ball valve. When the valve is closing from the open position, the valve member typically requires 13 degrees of additional rotation, past the point at which the throughbore in the valve member is no longer even partly aligned with the flow passage, in order for the valve member to reach the fully closed position. This additional rotation moves the throughbore far enough past the upstream seal, to preclude any leakage past the seal and into the throughbore. For example, if the valve is fully open at 0 degrees, the valve starts to close (i.e. the throughbore rotates past the seal) at 77 degrees, and is fully closed at 90 degrees. As the throughbore rotates past the seal at 77 degrees, the valve close-off pressure starts to rise toward a high pressure, of for example 150-200 pounds per square inch in a typical heating and cooling system installation.

The valve member also typically requires 13 degrees of rotation, from the point at which the valve starts to rotate out of the fully closed position, before the throughbore begins to be partly exposed to the flow passage, such that if the valve is fully closed at 90 degrees, the valve starts to open at 77 degrees, and is fully open at 0 degrees. Before the valve starts to open, between 90 and 77 degrees, the valve member is exposed to and must rotate against the full close-off pressure, of for example 150-200 pounds per square inch in a typical heating and cooling system installation.

For prior ball valves, the high close-off pressure pushes the ball constantly against the downstream seal when the valve is closed, and throughout the 13 degrees of rotation just after closing and just before opening. This results in a high compression force against the downstream seal, which creates high dynamic friction between the downstream seal and the valve member, and also generates significant elastic deformation of the relatively soft material of the downstream seal. The resulting compression force between the valve member and the downstream seal can also create a lack of fluid lubrication between the valve member and the downstream seal, which is manifested as higher dynamic friction. The high dynamic friction created by these inherent characteristics of prior traditional ball valves results in the actuator having to generate high rotational torque to rotate the ball through the 13 degrees just after the valve closes, or the 13 degrees of rotation just before the valve opens.

The third condition where torque is significantly increased, occurs when a ball valve is left in a closed position for extended lengths of time, while exposed to fluid on an upstream side of the valve. In ball valves used for controlling a flow of water or other cooling fluid in a cooling system for a building, for example, the ball valves may remain closed for several months of the year when the cooling system is inoperative. During such long periods, scale can build up on the valve member, and the seals can take a set, and dry out in a manner that will cause the torque required for repositioning the ball valve to an open position to be increased.

Specifically, after long periods of inactivity, when prior ball valves are kept in the closed position for 6 months or more, for example, the fluid at the inlet port cannot enter the chamber around the valve member, because the upstream seal completely blocks entry of the upstream fluid into the chamber. Because the outlet port is empty when the valve is closed, any fluid that remained in the chamber around the valve member when the valve was closed, eventually evaporates, and escapes through the downstream seal into the outlet port. Therefore, the interface of the seals with the valve member dries out, and the lubricating effect of the fluid is lost, which results in static and dynamic friction being increased. Foreign particles such as scale, dirt and wear particles in the space between the seals and the valve member also dry out and tend to bond the seals to the valve member, almost as if they were glued together. In order to break these bonds, so that the valve member can be repositioned after extended periods of inactivity, the breakaway torque will typically be several times higher than for shorter periods of inactivity when the seals do not dry out.

In addition, when the valve is closed, and stays closed while exposed to high close-off fluid pressure for the long period time, the high close-off pressure fluid pushes the valve member constantly against the downstream seal. This results in a high compression force that creates a high static friction between the downstream seal and the valve member, and also causes significant deformation of the soft material used for the seal, due to the low compressive strength of such seal materials. These conditions individually and in combination significantly increase static and dynamic friction between the seals and the valve member, requiring that the actuator generate an undesirably high breakaway torque to break loose and reposition the valve member.

In order for the actuators of prior ball valves to have enough torque to overcome the high breakaway torque, high static and dynamic friction, and other factors as discussed above, it has been necessary in the past to over-size the actuator, so that it will be able to provide sufficient torque to break the valve member loose and reposition it, under any of the operating conditions described above. This has required that the actuators in prior ball valves be physically larger and heavier, more costly, and consume more power during operation than would be the case if the inherently high torques encountered in prior ball valves could be reduced, especially under the three operating conditions described above.

In prior ball valves, conventional wisdom has long dictated that fluid not be left standing in a cavity formed by the outer surface of the valve member, in conjunction with the upstream and downstream seals and the valve body, when the valve member is in the closed position. The inventor has discovered, however, that the torque required for repositioning the valve member can be significantly reduced, by keeping the cavity filled with fluid when the valve member is in the closed position. Keeping the cavity filled with fluid during long periods of operation in the closed position has been found to be particularly advantageous in reducing the torque required for breaking loose the valve member, after initial installation of the ball valve, and after long periods of operation with the valve member in the closed position.

### BRIEF SUMMARY OF THE INVENTION

The invention provides an apparatus and method for reducing the torque required for repositioning a valve member of a ball valve, by maintaining continuous fluid communication between a cavity surrounding the valve member and an upstream flow-through end of a valve body of the ball valve, regardless of the alignment of the valve member with respect to the upstream flow-through end of the valve body.

The invention is applicable to ball valves having a valve body, and a valve member operatively connected to the valve body by an upstream and a downstream seal. The valve body defines a flow passage having an upstream flow-through end thereof, a downstream flow-through end thereof, and a valve receiving chamber therebetween. The valve member is disposed within the valve receiving chamber and includes a throughbore therein. The valve member is selectively rotatable about an axis within the valve receiving chamber between an open and a closed position, with the open position providing flow-through alignment of the throughbore in the valve member with the upstream and downstream flow-through ends of the valve body, and the closed position being out of flow-through alignment of the throughbore of the valve element with the upstream and downstream flow-through ends of the valve body. The upstream and a downstream seals operatively connect the valve member to the valve body, at upstream and downstream ends, respectively, of the valve receiving chamber. The seals, in conjunction with the valve member and the valve receiving chamber, define a cavity around the valve member.

In one form of the invention, the cavity around the valve member remains in continuous fluid communication with the upstream flow-through end of the valve body, regardless of the alignment of the valve member with respect to the upstream flow-through end of the valve body. The continuous fluid communication may be provided by a seal bypass passage, having an inlet connected in fluid communication with the upstream flow-through end of the valve body and an outlet connected in fluid communication with the cavity, to thereby provide fluid communication past the upstream seal between the upstream flow-through end of the valve body and the cavity. The seal bypass passage may be defined, alternatively, by the valve body, or the upstream seal, or by one or more holes passing through an outer wall of the valve member that faces toward the upstream flow-through end of the valve body when the valve member is in the closed position.

The invention may also take the form of a method for reducing the torque required for repositioning a valve member in a valve body of a ball valve of the type described above, by maintaining continuous fluid communication between the cavity around the valve member and the upstream flow-through end of the valve body, regardless of the alignment of the valve member with respect to the upstream flow through end of the valve body.

Other aspects, objectives and advantages of the invention will be apparent from the following detailed description and the accompanying drawings.

### BRIEF DESCRIPTION OF THE DRAWINGS

FIG. 1 is a cross section of a first exemplary embodiment of a ball valve, according to the invention, having a valve body including a seal bypass passage, with the valve shown in an open position.

FIG. 2 is a cross section of the first exemplary embodiment of FIG. 1, with the valve shown in a closed position.

FIG. 3 is a cross section of a second exemplary embodiment of a ball valve, according to the invention, having an upstream seal including a seal bypass passage, with the valve shown in a closed position.

FIGS. 4 and 5 are a cross section and a perspective view, respectively of a third exemplary embodiment of a ball valve, according to the invention, having valve member including a seal bypass passage in the form of a single hole through an outer wall of the valve member, with the valve shown in a closed position.

FIGS. 6 and 7 are a cross section and a perspective view, respectively of a fourth exemplary embodiment of a ball valve, according to the invention, having valve member including a seal bypass passage collectively formed by several holes through an outer wall of the valve member, with the valve shown in a closed position.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

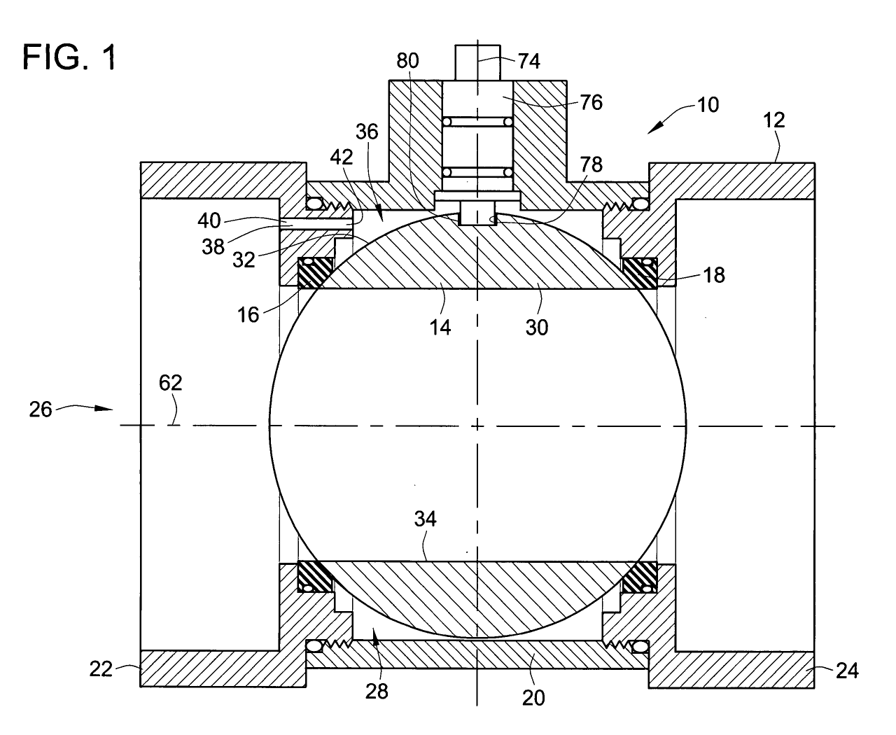

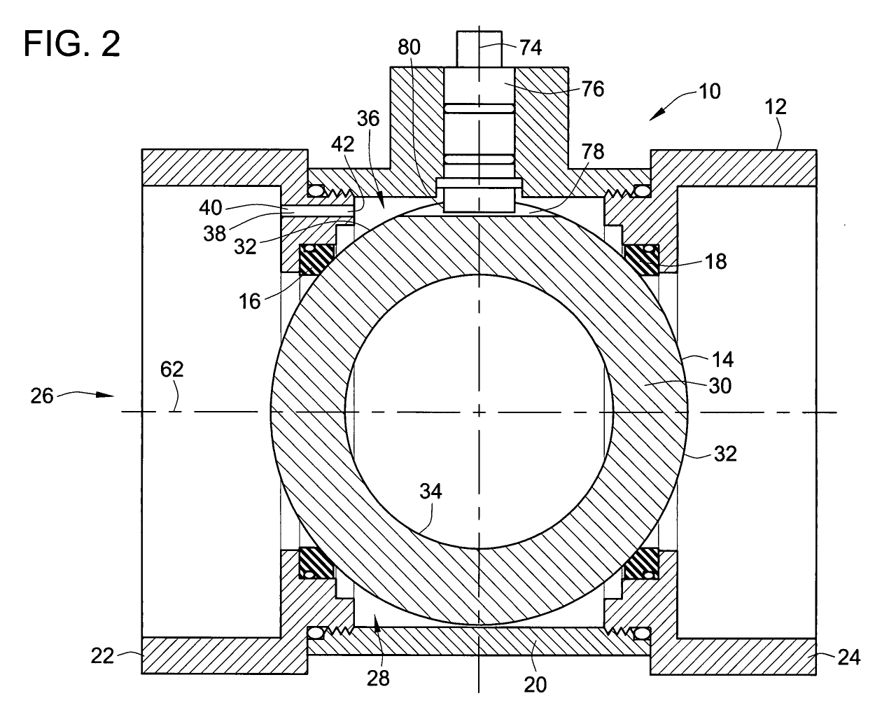

FIGS. 1 and 2 show a first exemplary embodiment of a ball valve 10, according to the invention. The ball valve 10 includes a valve body 12, and a valve member 14 operatively connected to the valve body 12 by an upstream and a downstream seal 16, 18.

The valve body 12 includes a central section 20, an upstream flow-through end 22, and a downstream flow-through end 24. The upstream and downstream flow-through ends 22, 24 are threadably joined to the central section 20, to form the valve body 12, and defines a flow passage 26 having an inlet formed by the upstream flow-through end 22, an outlet formed by the downstream flow-through end 24, and a valve receiving chamber 28 disposed between the upstream and downstream flow-through ends 22, 24.

The valve member 14 of the exemplary embodiment has an outer wall 30 defining a generally spherical shaped outer surface 32, and includes a throughbore 34 therein. The valve member 14 is disposed within the valve receiving chamber 28 of the valve body 12, as shown in FIG. 2.

The valve member 14 is selectively rotatable about an axis 74 within the valve receiving chamber 28, between an open position, as shown in FIG. 1 and a closed position, as shown in FIG. 2. In the open position, the throughbore 34 of the valve member is aligned in a flow-through alignment with the upstream and downstream flow-through ends 22, 24 of the valve body 12. In the closed position, the throughbore 34 is positioned in an out of flow-through alignment with the upstream and downstream flow-through ends 22, 24, to thereby block a flow of fluid through the ball valve 10.

The valve element 14 is operatively connected to the valve body 12 by the upstream and a downstream seals 16, 18. The upstream and downstream seals 16, 18 are clamped in sealing contact with the spherical outer surface 32 of the valve element 14, by the upstream and downstream flow-through ends 22, 24 of the valve body 12, at upstream and downstream ends, respectively, of the valve receiving chamber 28.

The upstream and downstream seals 16, 18, in conjunction with the valve member 14 and the valve receiving chamber 28, define a cavity 36 around the valve member 14, within the valve receiving chamber 28. When the valve member 14 is in the closed position, as shown in FIG. 2, the cavity 36 is closed, and cannot exchange fluid with either the upstream or downstream flow-through ends 22, 24 of the valve body 12.

In the first exemplary embodiment of the invention, as shown in FIGS. 1 and 2, the upstream flow-through end 22 of the valve body 12 includes a seal bypass passage 38 that allows the cavity 36, around the valve member 14, to remain in continuous fluid communication with the interior of the upstream flow-through end 22 of the valve body 12, regardless of the alignment of the throughbore 34 of the valve member 14 with respect to the upstream flow-through end 22 of the valve body 12. The seal bypass passage 38 includes an inlet 40 connected in fluid communication with the upstream flow-through end 22 of the valve body 12, and an outlet 42 connected in fluid communication with the cavity 36 around the valve member 14, to thereby provide fluid communication past the upstream seal 16, so that fluid can be exchanged between the upstream flow-through end 22 of the valve body 12 and the cavity 36, even when the valve member 14 is in the closed position.

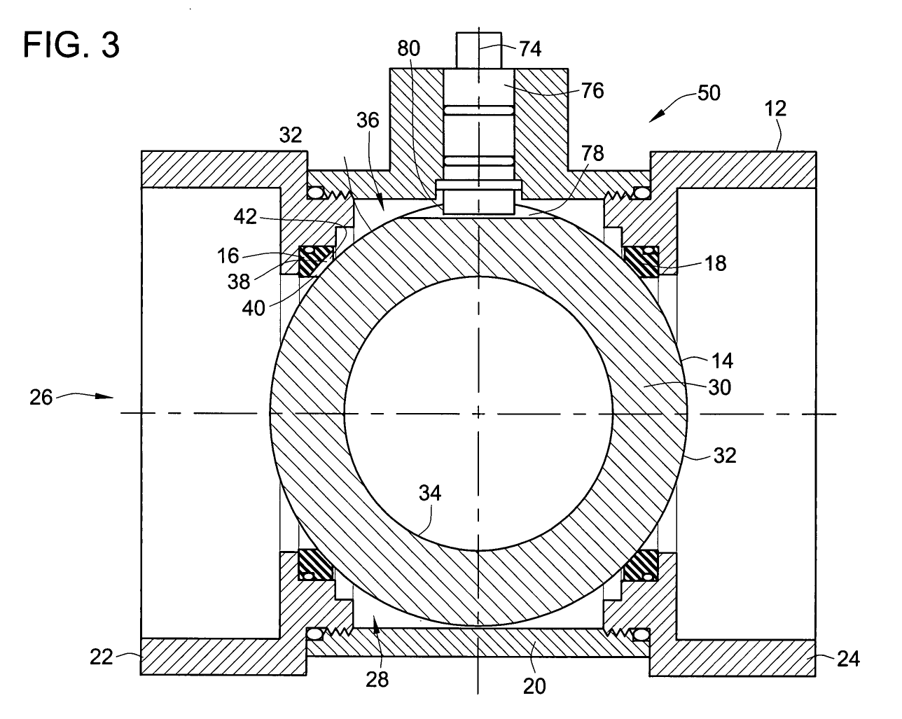

FIG. 3 shows a second exemplary embodiment of a ball valve 50, according to the invention. The ball valve 50 of the second exemplary embodiment is essentially identical with the ball valve 10 of the first exemplary embodiment, except that the seal bypass passage 38 is located in the upstream seal 16, rather than being located in the upstream flow-through end 22, as was the case in the first exemplary embodiment of the ball valve 10 shown in FIGS. 1 and 2.

In the second exemplary embodiment, shown in FIG. 3, the seal bypass passage 38 is formed by a single notch, or groove, in a surface of the upstream seal 16 that otherwise provides uninterrupted fluid-tight contact with the outer spherical surface 32 of the valve member 14. In alternate embodiments of the invention, multiple notches in the surface of the upstream seal 16 may be used, or the seal may define one or more holes, or grooves, therein that form the seal bypass passage 38.

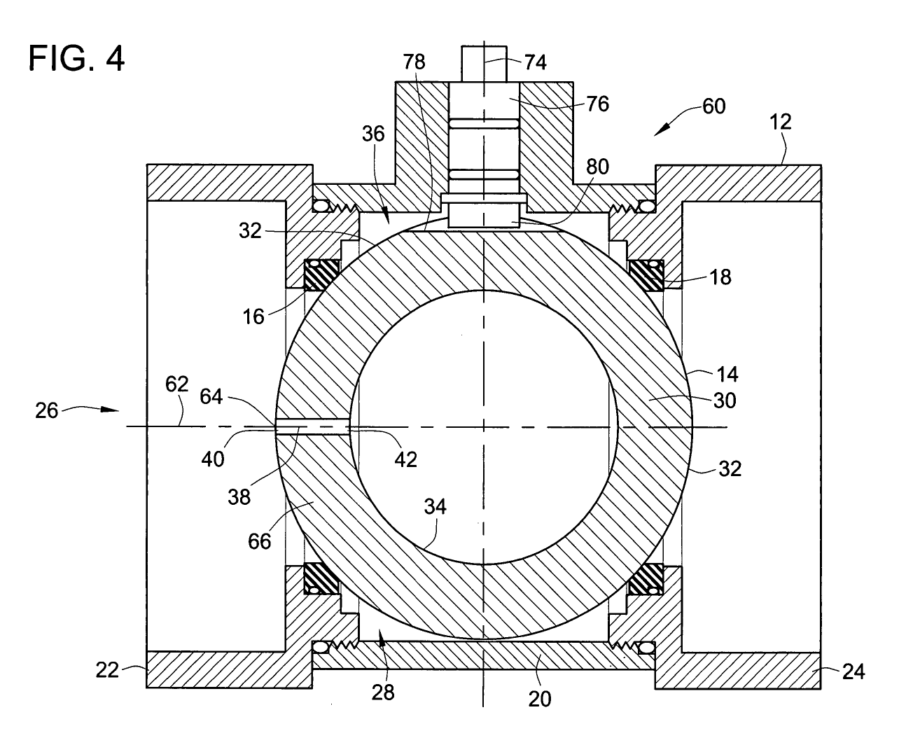

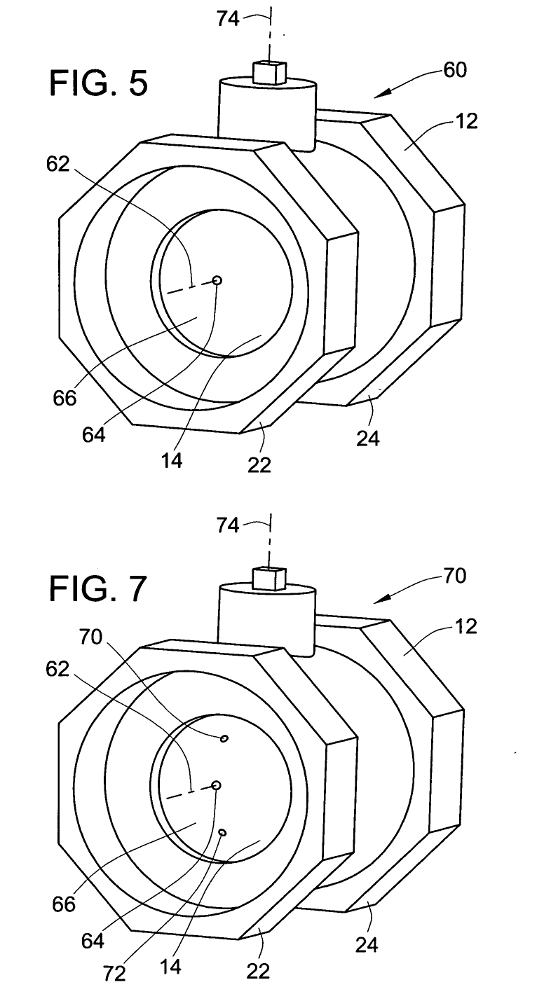

FIGS. 4 and 5 show a third exemplary embodiment of a ball valve 60, according to the invention. The ball valve 60 of the third exemplary embodiment is essentially identical with the ball valves 10 and 50 of the first and second exemplary embodiments, except that the seal bypass passage 38 is located in the valve member 14, rather than being located in the upstream flow-through end 22, as was the case in the first exemplary embodiment of the ball valve 10 shown in FIGS. 1 and 2, or in the upstream seal 16, as was the case in the second exemplary embodiment shown in FIG. 3.

As shown in FIGS. 4 and 5, in the ball valve 60 of the third exemplary embodiment, the valve body 12 defines a longitudinal centerline 62 of the flow passage 26, extending through the valve member 14. The seal bypass passage 38 is formed by a single straight sided hole 64 extending along the longitudinal centerline 62, through a section 66 of the outer wall 30 of the valve member 14 that faces the upstream flow-through end 22 of the valve body 14, when the valve member 14 is in the closed position. It will also be understood, by those having skill in the art that the hole 64 in the valve element 14 of the third exemplary embodiment extends along a radius of the spherical outer surface 32 of the valve element 14.

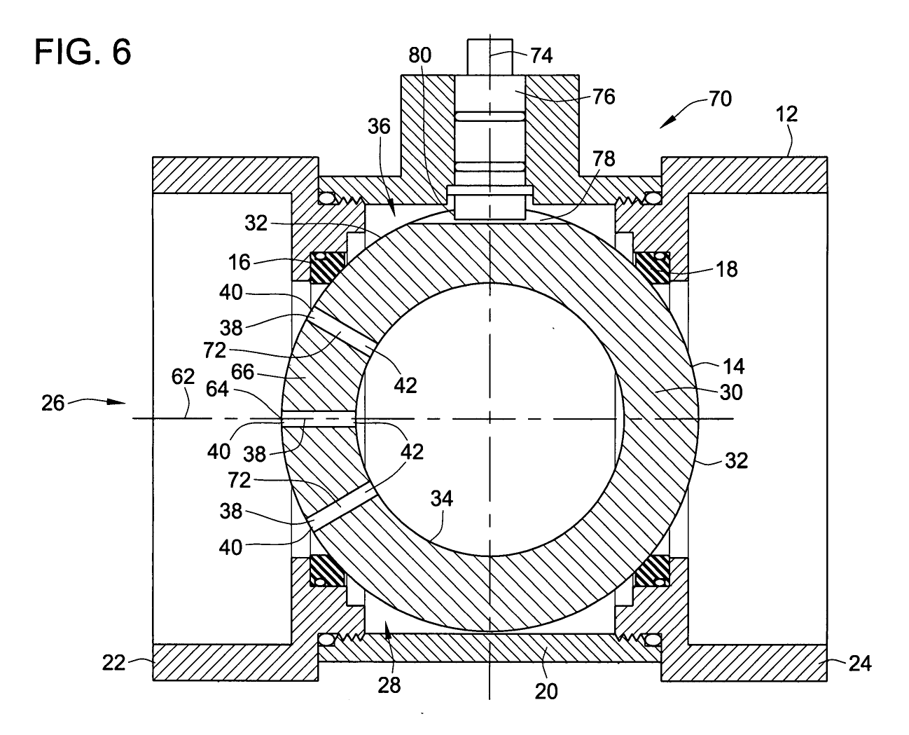

FIGS. 6 and 7 show a fourth exemplary embodiment of a ball valve 70, according to the invention. The ball valve 70 of the fourth exemplary embodiment is essentially identical with the ball valves 60 of the third exemplary embodiment, except that the valve member 14 includes a plurality of holes 64, 72, rather than only a single hole 64, as was the case in the second third embodiment shown in FIGS. 4 and 5.

As shown in FIGS. 6 and 7, in the ball valve 70 of the fourth exemplary embodiment, the valve body 12 defines a longitudinal centerline 62 of the flow passage 26, extending through the valve member 14. The seal bypass passage 38 is formed collectively by a three straight-sided holes 64, 72, 72. A centrally located hole 64 extends along the longitudinal centerline 62, through a section 66 of the outer wall 30 of the valve member 14 that faces the upstream flow-through end 22 of the valve body 14, when the valve member 14 is in the closed position, as was the case in the ball valve 60 of the third exemplary embodiment. It will also be understood, by those having skill in the art that the centrally located hole 64 in the valve element 14 of the fourth exemplary embodiment extends along a radius of the spherical outer surface 32 of the valve element 14.

In the ball valve 70, the valve member 14 is rotatable about an axis 74 extending perpendicularly through the longitudinal centerline 62 of the valve body 12. The three holes 64, 72, 72 that collectively form the seal bypass passage 38, extend through the outer wall 30 of the valve member 14, and lie in a common (vertical as shown in FIGS. 6 and 7) flat plane including both the axis 74 and the longitudinal centerline 62.

Those having skill in the art will readily recognize that, by connecting the cavity 36 to the upstream flow-through end 22 of the valve body 12 with one or more seal bypass passages 38, fluid communication past the upstream seal 16 is provided, to thereby allow the cavity 36 to exchange fluid with the upstream flow-through end 22 of the valve body 12 when the valve member 14 is disposed in the closed position. In this manner, continuous fluid communication is maintained between the cavity 36 and the upstream flow-through end of the valve body 22, regardless of the alignment of the valve member 14 with respect to the upstream through end 22 of the valve body 12. As a result the cavity 36 will remain filled with fluid whenever fluid is present in the upstream flow-through end 22 of the valve body and the valve member 14 is in either the closed position or the fully open position, for achieving the torque reducing effect observed by the inventor.

In all of the embodiments shown herein, the valve member 14 is operatively connected to a shaft 76, that extends through the central portion 20 of the housing, for turning the valve member 14 about the axis 74, so that the valve member 14 can be selectively positioned in either the open or the closed position, or any position in between the open and closed position. In order to provide the greatest freedom for the valve member 14 to float within the valve receiving chamber 28, and achieve a low friction fit with the upstream and downstream seals 16, 18, it is desirable that the connection between the shaft 76 and the valve member 14 be articulated in some fashion, to preclude having the connection between the shaft 76 and the valve member 14 restrict free movement of the valve member in the valve receiving chamber 28.

In the embodiments shown herein, such an articulated connection between the shaft 74 and the valve member 14 is accomplished through the use of a judiciously oriented slot 78, in the valve member 14, which engages a flattened inner end 80 of the shaft 74. The slot 78 has sidewalls that are preferably oriented parallel to the axis 62 of the valve body 12, when the valve member 14 is in the closed position as shown in FIGS. 1, and 3-7. The slot 78 and the flattened inner end 80 of the shaft 76 are cooperatively configured to provide a slight clearance between the slot 78 and the flattened inner end 80 of the shaft 76. With the slot 78 oriented and configured in this manner, the valve member 14 can float axially between the upstream and downstream seals 16, 18 when the valve member 14 is in the closed position.

In other embodiments of the invention, other articulating drive arrangements may be used to connect a shaft 76 to the valve member 14, in a manner that provides a similar freedom for the valve member 14 to float axially, when the valve member 14 is in the closed position. In particular, it is noted that, although the lower surface of the slot 78, connecting the sidewalls of the slot 78, is shown in FIGS. 1-4 and 7 as being flat and perpendicular to the axis 74 of the shaft 76, in other articulating drive arrangements according to the invention, the lower surface of the slot 78 may be curved in a manner known in the art.

Those having skill in the art will also recognize that, although invention has been described herein with reference to several exemplary embodiments, many other embodiments of the invention are possible. For example, although all of the exemplary embodiments described herein utilize a valve element having a spherical outer surface 32, the invention may also be practiced to advantage in ball valves having non-spherical shaped valve elements. The features comprising the seal bypass passages 38 in the various exemplary embodiments described herein are all shown as being straight-sided. In other embodiments, the seal bypass passages 38 need not be straight-sided. The holes 64, 72 in the valve element 14 are illustrated herein as having a cross sectional area that is small in comparison to the size of the throughbore 34 in the valve member 14. Generally this size relationship is desirable where the valve element 14 is used to modulate flow, while partially opened, because, as the valve element 14 operates at a nearly closed position, the percentage of the spherical surface 32 that is cut away by the holes will not significantly affect the operating characteristics of the valve. Where modulation is not required, however, holes of a larger relative size may be preferable in some applications. The holes 64, 72 also need not be oriented radially, with respect to the outer surface of a spherical valve element, in other embodiments of the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A ball valve comprising:
a valve body defining a flow passage having an upstream flow-through end thereof, a downstream flow-through end thereof and a valve receiving chamber therebetween;
a valve member disposed within the valve receiving chamber and having a throughbore therein, the valve member being selectively movable within the valve receiving chamber between an open and a closed position, the open position providing flow-through alignment of the throughbore with the upstream and downstream flow-through ends of the valve body, and the closed position providing an out of flow-through alignment of the throughbore with the upstream and downstream flow-through ends of the valve body for blocking flow through the flow passage; and
an upstream and a downstream seal operatively connecting the valve member to the valve body at upstream and downstream ends respectively of the valve receiving chamber;
the seals, in conjunction with the valve member and the valve receiving chamber, defining a cavity around the valve member that remains in continuous fluid communication with the upstream flow-through end of the valve body, regardless of the alignment of the valve member with respect to the upstream and downstream flow through ends of the valve body.

2. The ball valve of claim 1, further comprising an apparatus providing continuous fluid communication between the upstream flow-through end of the valve body and the closed cavity.

3. The ball valve of claim 1, wherein the apparatus providing continuous fluid communication between the upstream flow-through end of the valve body and the closed cavity is a seal bypass passage, having an inlet connected in fluid communication with the upstream flow-through end of the valve body and an outlet connected in fluid communication with the closed cavity, to thereby provide fluid communication past the upstream seal between the upstream flow-through end of the valve body and the closed cavity.

4. The ball valve of claim 3, wherein the valve body includes the seal bypass passage.

5. The ball valve of claim 3, wherein the upstream seal includes the bypass passage therein, to thereby provide fluid communication past the upstream seal between the upstream flow-through end of the valve body and the closed cavity.

6. The ball valve of claim 3, wherein the valve member includes an outer wall thereof for blocking flow through the ball valve when the valve member is in the closed position with the outer wall facing the upstream flow-through end of the valve body, and the outer wall of the valve member includes the bypass passage, the bypass passage having first and second open ends thereof, the first open end providing fluid communication with the upstream flow-through end of the valve body, and the second open end providing fluid communication with the throughbore of the valve member, when the valve member is in the closed position.

7. The ball valve of claim 6, wherein the seal bypass passage includes a straight hole extending through the outer wall of the valve member.

8. The ball valve of claim 7, wherein:
the valve body defines a longitudinal centerline of the flow passage extending through the valve member; and
the hole through the outer wall of the valve member extends along the longitudinal centerline.

9. The ball valve of claim 7, wherein the outer wall of the valve member defines a spherical outer surface thereof for contacting the upstream seal, and the straight hole extends along a radius of the spherical outer surface.

10. The ball valve of claim 9, wherein the bypass passage includes multiple straight holes extending through the outer wall of the valve member.

11. The ball valve of claim 10, wherein:
the valve body defines a longitudinal centerline of the flow passage extending through the valve member;
the valve member is rotatable about an axis extending perpendicularly through the longitudinal centerline; and
the holes through the outer wall of the valve member lie in a common flat plane including the axis and the longitudinal centerline.

12. An apparatus for reducing the torque required for repositioning a valve member of a ball valve, in a ball valve having a valve body, a valve member operatively connected to the valve body by an upstream seal and a downstream seal, wherein the valve body defines a flow passage having an upstream flow-through end thereof, a downstream flow-through end thereof and a valve receiving chamber therebetween, the valve member is disposed within the valve receiving chamber and includes a throughbore therein, with the valve member being selectively rotatable about an axis within the valve receiving chamber between an open and a closed position, the open position providing flow-through alignment of the throughbore with the upstream and downstream flow-through ends of the valve body, and the closed position being out of flow-through alignment of the throughbore with the upstream and downstream flow-through ends of the valve body, the upstream and a downstream seals operatively connecting the valve member to the valve body at upstream and downstream ends respectively of the valve receiving chamber, with the seals, in conjunction with the valve member and the valve receiving chamber, defining a cavity around the valve member, the apparatus comprising:
means for maintaining continuous fluid communication between the cavity and the upstream flow-through end of the valve body, regardless of the alignment of the valve member with respect to the upstream flow through end of the valve body.

13. The apparatus of claim 12, wherein the means for maintaining continuous fluid communication between the cavity and the upstream flow-through end of the valve body comprises, a seal bypass passage, having an inlet connected in fluid communication with the upstream flow-through end of the valve body and an outlet connected in fluid communication with the cavity, to thereby provide fluid communication past the upstream seal and allow the cavity to exchange fluid with the upstream flow-through end of the valve body when the valve member is disposed in the closed position.

14. The apparatus of claim 13, comprising a valve body for a ball valve, wherein the valve body includes the seal bypass passage.

15. The apparatus of claim 13, comprising an upstream seal for a ball valve, wherein the upstream seal includes the seal bypass passage therein.

16. The apparatus of claim 13, comprising a valve member for a ball valve, wherein the valve member includes an outer wall thereof for blocking flow through the ball valve when the valve member is in the closed position with the outer wall facing the upstream flow-through end of the valve body, and the outer wall of the valve member includes the bypass passage, the bypass passage having first and second open ends thereof, the first open end being adapted for providing fluid communication with the upstream flow-through end of a valve body of a ball valve in which the valve member is installed, and the second open end providing fluid communication with the throughbore of the valve member, when the valve member disposed in a closed position while installed in the valve body of the ball valve in which the valve member is installed.

17. A method for reducing the torque required for repositioning a valve member of a ball valve, in a ball valve having a valve body a valve member operatively connected to the valve body by an upstream and a downstream seal, wherein the valve body defines a flow passage having an upstream flow-through end thereof, a downstream flow-through end thereof and a valve receiving chamber therebetween, the valve member is disposed within the valve receiving chamber and includes a throughbore therein, with the valve member being selectively rotatable about an axis within the valve receiving chamber between an open and a closed position, the open position providing flow-through alignment of the throughbore with the upstream and downstream flow-through ends of the valve body, and the closed position being out of flow-through alignment of the throughbore with the upstream and downstream flow-through ends of the valve body, the upstream and a downstream seals operatively connecting the valve member to the valve body at upstream and downstream ends respectively of the valve receiving chamber, with the seals, in conjunction with the valve member and the valve receiving chamber, defining a cavity around the valve member, the method comprising:
maintaining continuous fluid communication between the cavity and the upstream flow-through end of the valve body, regardless of the alignment of the valve member with respect to the upstream flow through end of the valve body.

18. The method of claim 17, further comprising, connecting the cavity to the upstream flow-through end with a seal bypass passage providing fluid communication past the upstream seal, to thereby allow the cavity to exchange fluid with the upstream flow-through end of the valve body when the valve member is disposed in the closed position.

19. The method of claim 18, wherein the valve body includes the seal bypass passage therein.

20. The method of claim 18, wherein the upstream seal includes the seal bypass passage therein.

21. The method of claim 18, wherein the valve member of the ball valve includes an outer wall thereof for blocking flow through the ball valve when the valve member is in the closed position with the outer wall facing the upstream flow-through end of the valve body, and the outer wall of the valve member includes the bypass passage therein.
